(19) United States
(12) Patent Application Publication
(10) Pub. No.: US 2003/0131949 A1
(43) Pub. Date: Jul. 17, 2003

(54) Water-obstructed roller shutter structure

(76) Inventor: Chih-Chung Wu, (US)

Correspondence Address: TROXELL LAW OFFICE PLLC, SUITE 1404, 5205 LEESBURG PIKE, FALLS CHURCH, VA, 22041, US

(21) Appl. No.: 10/318,135

(22) Filed: Dec. 13, 2002

(30) Foreign Application Priority Data
Dec. 17, 2001 (TW) 090222270

(51) Int. Cl. E06B 9/08

(52) U.S. Cl. 160/133

(57) ABSTRACT

This invention provides a water-obstructed roller shutter structure comprising: a plurality of boards, each of which forms a containing groove at its bottom edge and top edge respectively, and every containing groove is designed to hold a waterproof strip; a top shaft and a bottom shaft at inner side of each board; a waterproof strip at the bottom of the last board, clinging to the metal bar on the ground; a plurality of stay bars, including a top stay bar hinged to said top shaft, a bottom stay bar hinged to said bottom shaft, the bottom end of said top stay bar and the top end of said bottom stay bar are hinged to a center shaft, and stay bars between adjacent columns are staggered; a side chamber at each side of the roller shutter, each side chamber has a front sealing element fixed on its front surface and a back sealing element fixed on its inner side surface near said boards, and a side sealing element beside said board.

### FIELD OF THE INVENTION

This invention is related to a roller shutter, in particular a water-obstructed roller shutter structure.

### BACKGROUND OF THE INVENTION

Currently, many houses are equipped with steel roller shutters against burglars besides locks. Not long ago, flood invaded many areas. Hence many people added a flood gate before the steel roller shutter. However, a flood gate consumes a large floor space, resulting in inconvenience.

### SUMMARY OF THE INVENTION

Besides anti-burglar function, the roller shutter structure in present invention delivers water obstructed function without occupying additional floor area.

The features, functions, and advantages of the present invention will be readily understood upon a thoughtful deliberation of the following detailed description of two preferred embodiments of the present invention with reference to the accompanying drawings.

### BRIEF DESCRIPTION OF THE DRAWINGS

FIG. 1 is a 3D view of the roller shutter structure in present invention in the normal ventilation state.

FIG. 2 is an amplified plane view of Part A in FIG. 1.

FIG. 3 is a sectional view of a board.

FIG. 4 shows the connection between adjacent boards.

FIG. 5 shows the bottom tie bars (24) at the bottom of the last board and the assembly structure with the metal bar (18).

FIG. 6 is a inside view of the components in FIG. 5.

FIG. 7 shows the top tie bars (25) at the top of the first board.

FIG. 8 is a sectional view (line 8-8) of the components in FIG. 1.

FIG. 9 is a sectional view (line 9-9) of the components in FIG. 1.

FIG. 10 shows the stay bars (20) when the roller shutter in the present invention is in water obstructed state.

FIG. 11 shows the bottom tie bars (24) at the bottom of the last board when the roller shutter in the present invention is in water obstructed state.

FIG. 12 shows the top tie bars (25) at the top of the first board when the roller shutter in the present invention is in water obstructed state.

FIG. 13 shows the actions of the front sealing element (31), the back sealing elements (32), and the side sealing element (33).

FIG. 14 shows the action state of the side sealing element (33).

FIG. 15 shows another type of stay bars (20).

FIG. 16 is an upward view of the components in FIG. 15 when the roller shutter is in water obstructed state.

FIG. 17 shows another type of stay bards (20).

FIG. 18 is an upward view of the components in FIG. 17 when the roller shutter is in water obstructed state.

### DETAILED DESCRIPTION OF THE PREFERRED EMBODIMENTS

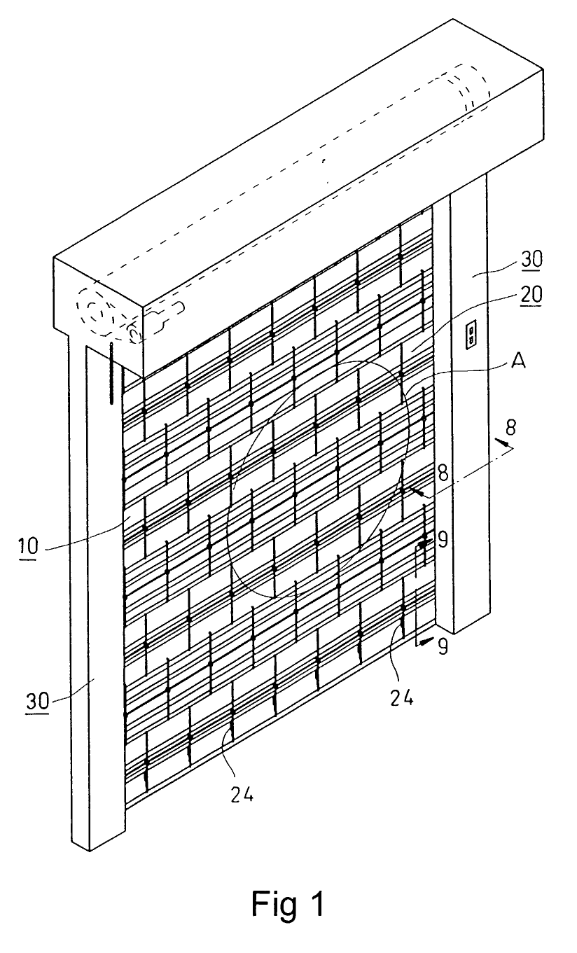

Please see FIG. 1 FIG. 9. The present invention comprises:

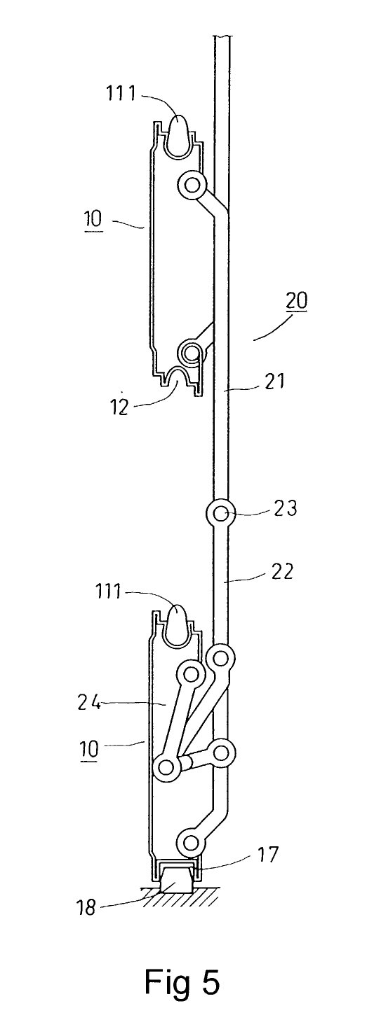

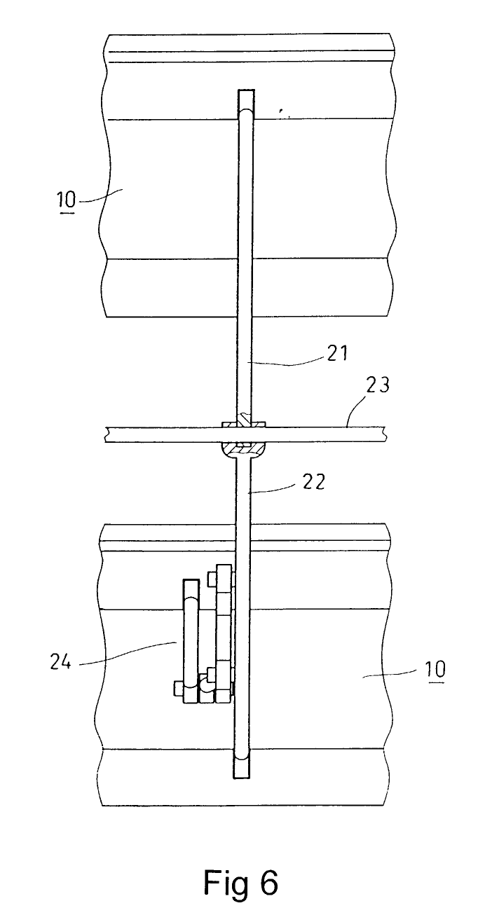

a plurality of boards (10), each of which has a top containing groove (11) and a bottom containing groove (12) at its top edge and bottom edge respectively, and said top containing groove is stuffed with a waterproof strip (111), said waterproof strip (111) protrudes out of said top containing groove (11); a top roll rim (13) and a bottom roll rim (15) at inner side of each board to host a top shaft (14) and a bottom shaft (16) respectively; a plastic waterproof strip (17) in the [symbol] ” shape bottom containing groove of the last board, clinging to the metal bar (18) (made of copper or stainless steel) on the ground (shown in FIG. 5 and FIG. 6);

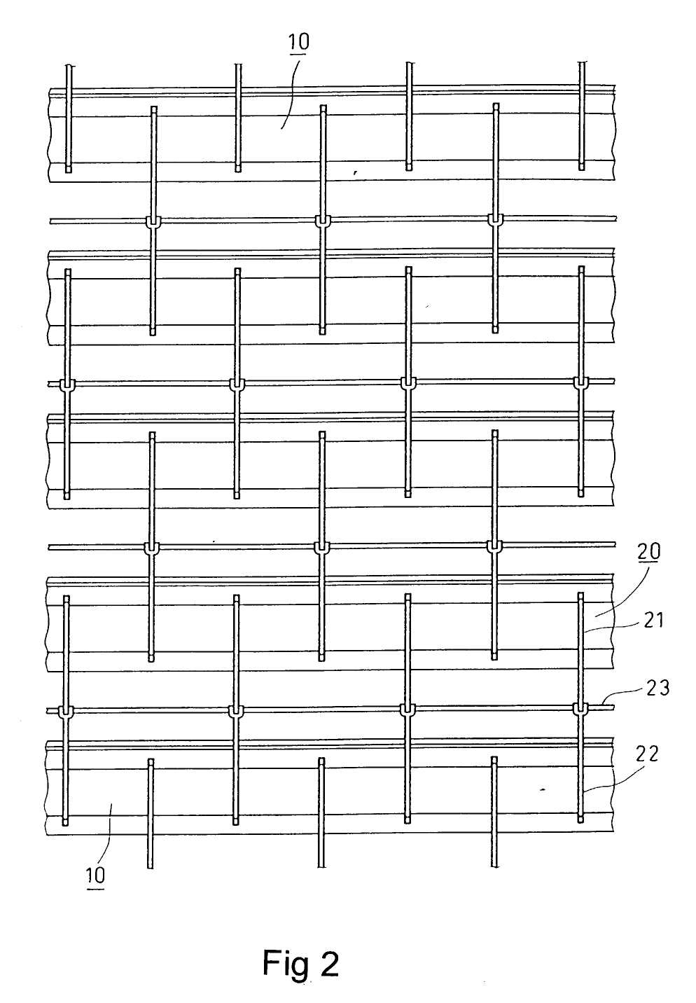

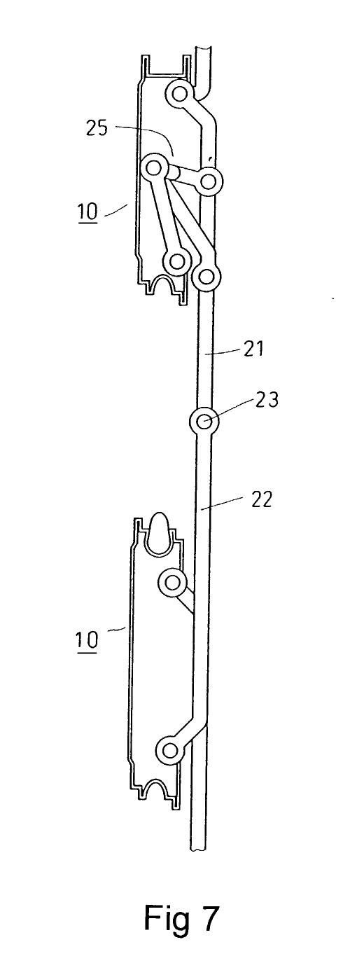

a plurality of stay bars (20), including a top stay bar (21) hinged to said top shaft (14), bottom stay bar (22) hinged to said bottom shaft (16), the bottom end of said top stay bar (21) and the top end of said bottom (22) stay bar are hinged to a center shaft (23), and stay bars (20) between adjacent columns are staggered (shown in FIG. 1 and FIG. 2), the top shaft (14) and the bottom stay bar (22) of the last board are connected to a plurality of bottom tie bar (24) (shown in FIG. 5), the bottom shaft (16) of the first board is connected to the top stay bar (21) via a plurality of top tie bar (25) (shown in FIG. 7);

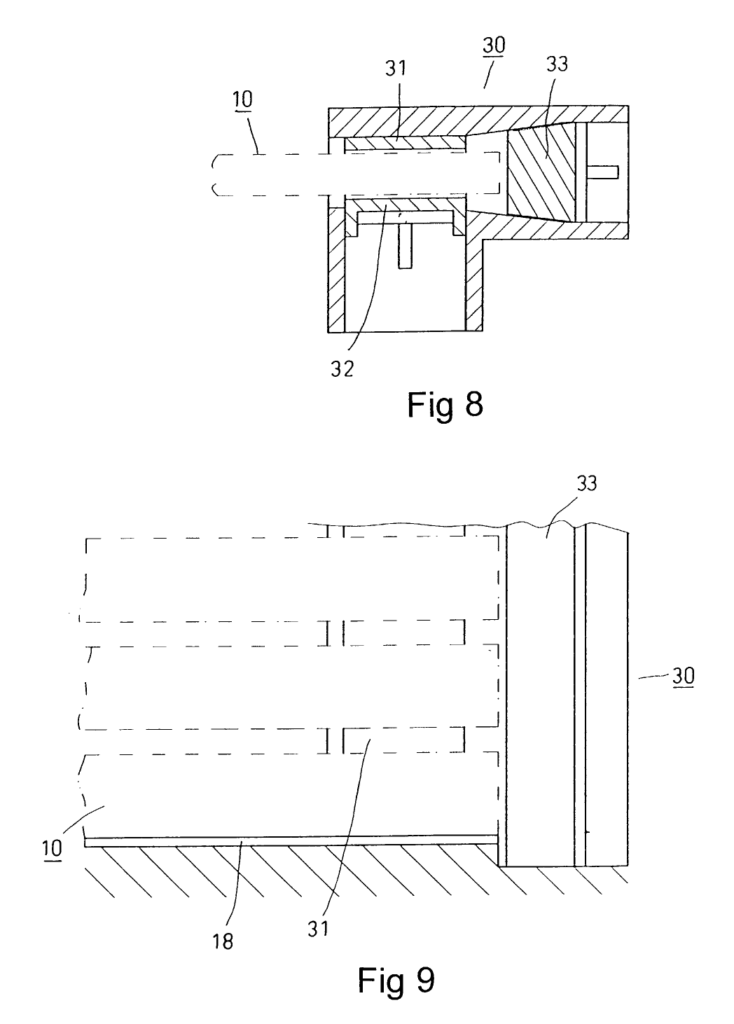

a side chamber (30) at each side of the roller shutter (shown in FIG. 8), the right side chamber (30) has a front sealing element (31) vertically fixed on its front surface, a back sealing element (32) vertically fixed on its inner side surface near said boards (10), and a side sealing element (33) vertically fixed beside said boards (10).

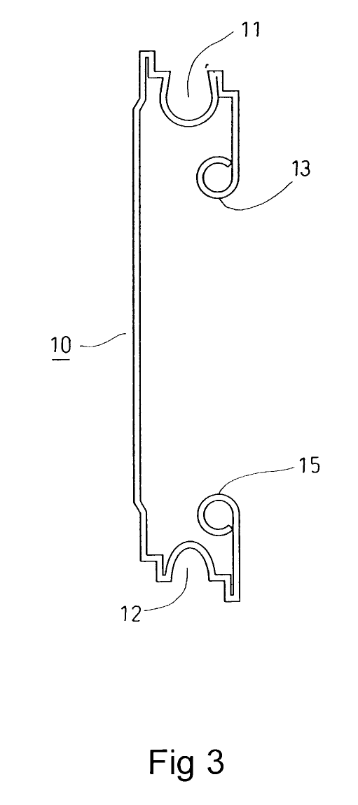

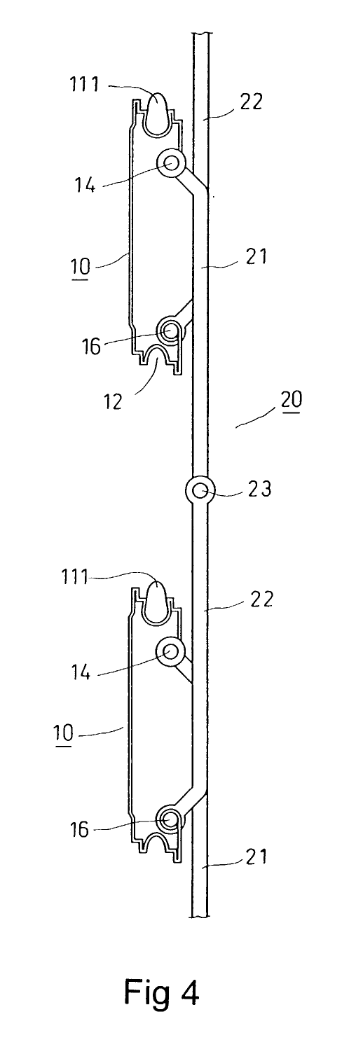

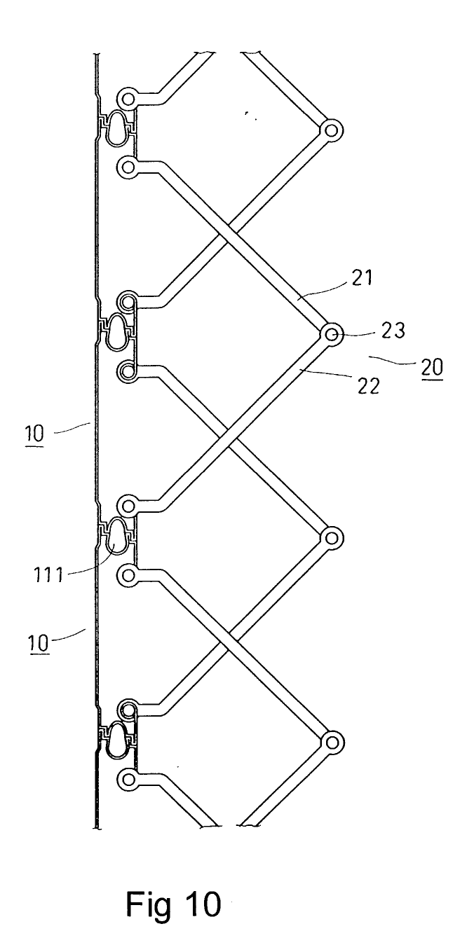

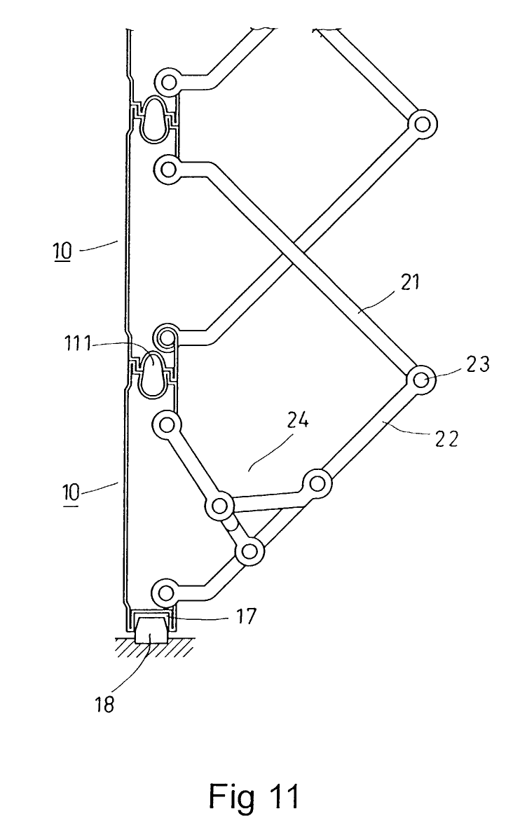

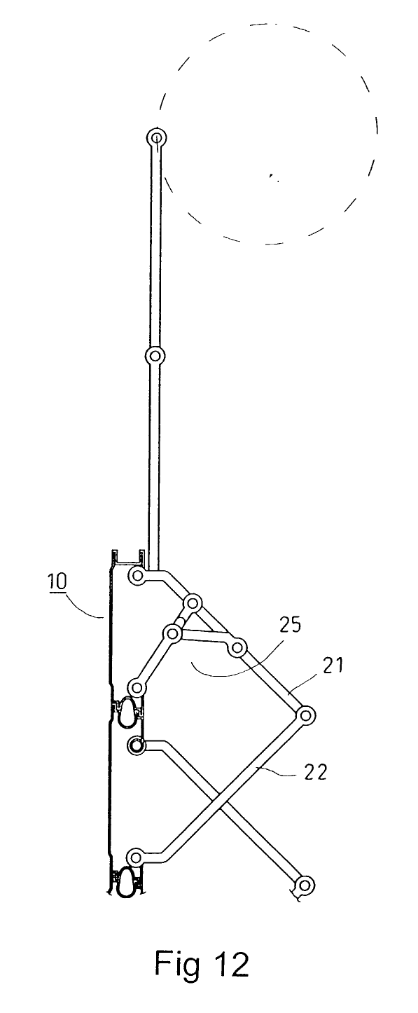

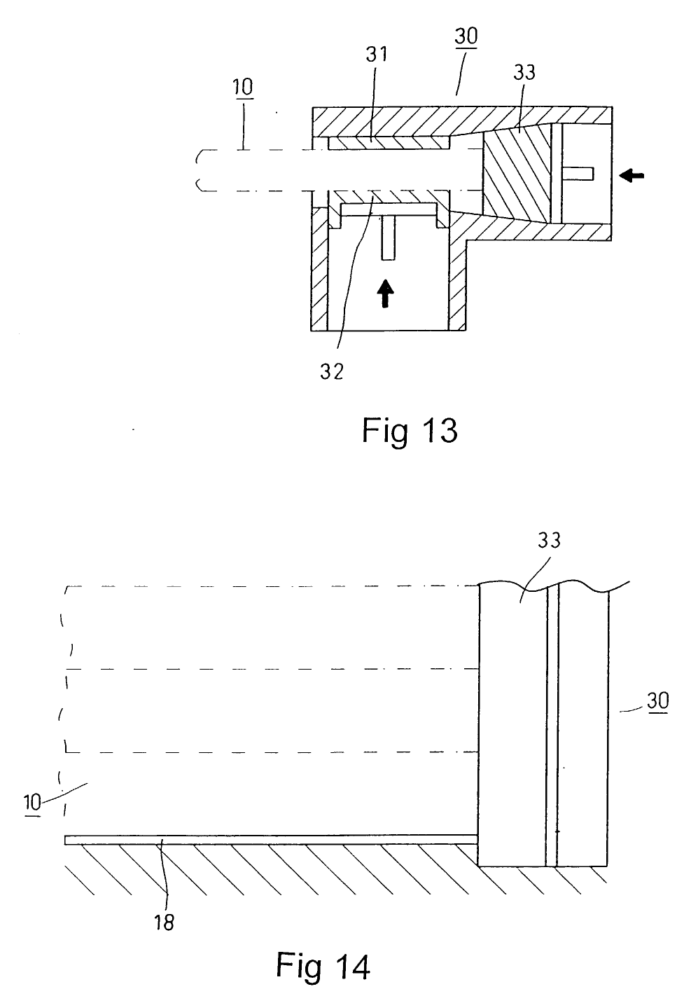

FIG. 1-FIG. 9 show the components of the invention in the normal ventilation state, i.e., there are preset interspaces between boards (10). When the invention is to be used to obstruct flood, the operator may press a button or a switch (or operate manually at power blackout) to make the boards contact with each other seamlessly (as shown in FIG. 10-FIG. 12). in this case, the stay bars (20) form “<” shapes, and the front sealing element (31) and the back sealing element (32) are pressed firmly to the exterior surfaces and the interior surfaces of the boards (10) under the pressure of a pressing component (not shown); while the side sealing elements (33) are also pressed firmly to the two sides of the boards (10) under the pressure of a pressing component (not shown). In this way, flood is obstructed outside. The present invention may also be installed at the entrance of basement.

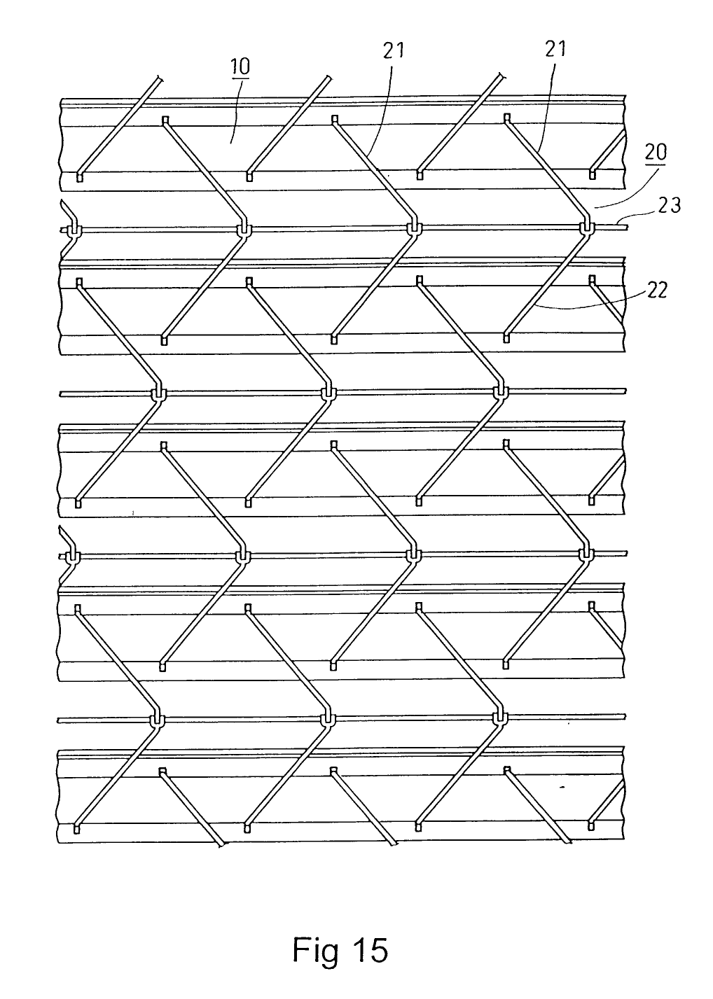

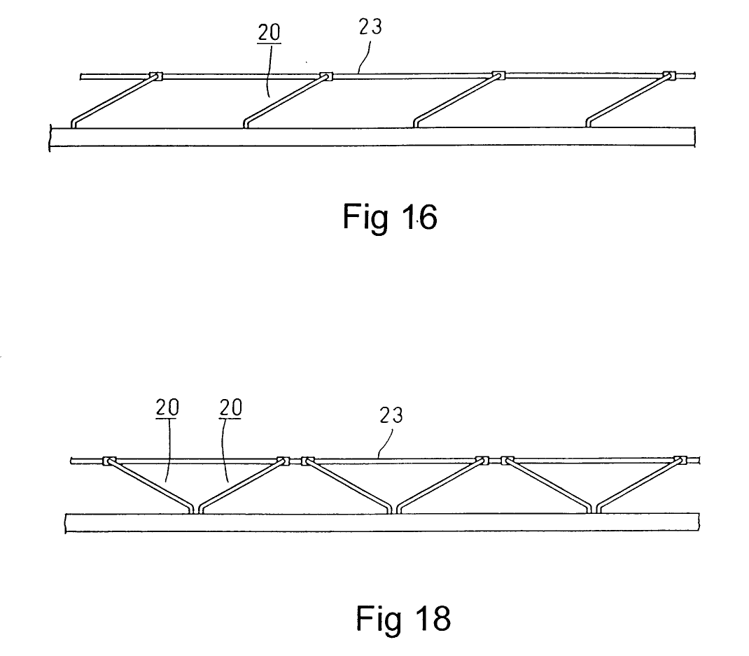

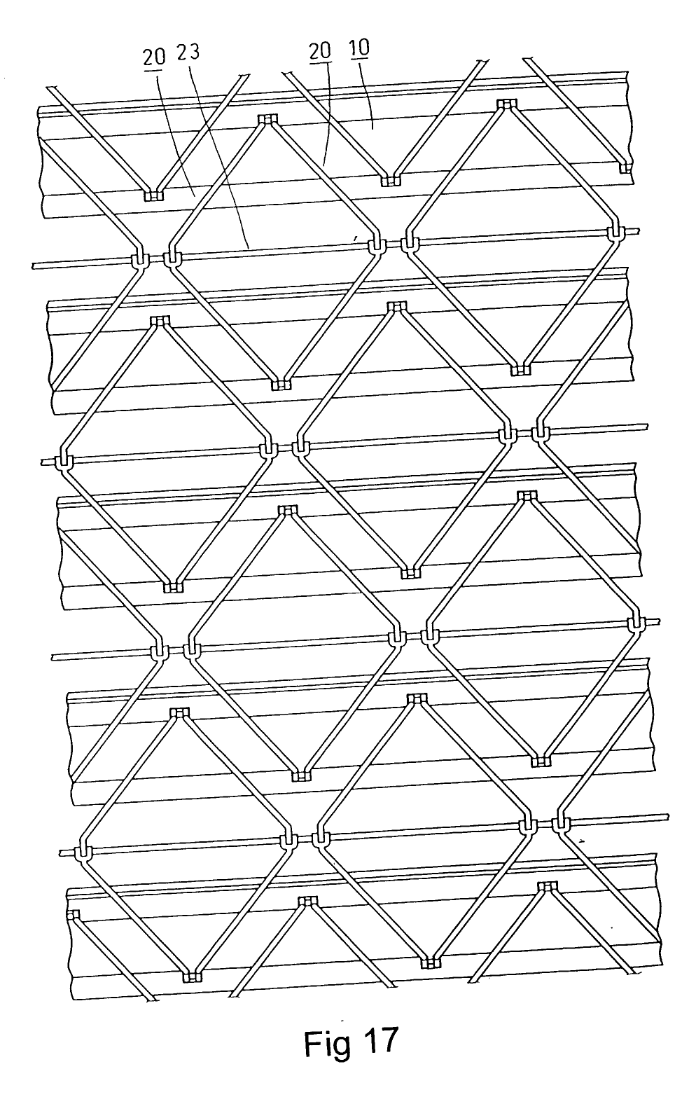

Please see FIG. 15 and FIG. 16, wherein said stay bars (20) can also be slant ones. FIG. 17 and FIG. 18 show another type of the stay bars (20). Other types may also be acceptable.

What is claimed is:

1. A water-obstructed roller shutter structure, comprising:
a plurality of boards, each of which forms a top containing groove and a bottom containing groove at its top edge and bottom edge respectively, and said top containing groove is stuffed with a waterproof strip, said waterproof strip protrudes out of said top containing groove; a top roll rim and a bottom roll rim at inner side of each board to host a top shaft and a bottom shaft respectively; a plastic waterproof strip in the “ [symbol] ” shape bottom containing groove of the last board, clinging to a metal bar on the ground when said roller shutter is closed;
a plurality of stay bars, including a top stay bar hinged to said top shaft, a bottom stay bar hinged to said bottom shaft, the bottom end of said top stay bar and the top end of said bottom stay bar are hinged to a center shaft, and stay bars between adjacent columns are staggered, the top shaft and the bottom stay bar of the last board are connected to a plurality of bottom tie bars, the bottom shaft of the first board is connected to the top stay bar of said first board via a plurality of top tie bars;
a side chamber at each side of said roller shutter, the right side chamber has a front sealing element vertically fixed on its front surface, a back sealing element vertically fixed on its inner side surface near said boards, and a side sealing element vertically fixed beside said boards;
in water obstructed state, said boards contact with each other seamlessly; said stay bars form ” shapes, and said front sealing element and said back sealing element is pressed firmly to the exterior surfaces and the interior surfaces of said boards; said side sealing elements are also pressed firmly to the two sides of said boards (10).
